(19) United States
(12) Patent Application Publication
(10) Pub. No.: US 2001/0000561 A1
(43) Pub. Date: May 3, 2001

(54) Heat-retaining boxing and holding method for pizza

(76) Inventor: John D. Correll, Canton, MI (US)

Correspondence Address: John D. Correll, 8459 Holly Dr., Canton, MI, 48187-4237, US

(21) Appl. No.: 09/730,294

(22) Filed: Dec. 5, 2000

Related U.S. Application Data
(63) Continuation-in-part of application No. 09/551,245, filed on Apr. 17, 2000.
(63) Continuation-in-part of application No. 09/394,784, filed on Sep. 13, 1999.
Application No. 09/394,784 is a continuation-in-part of application No. 09/061,302, filed on Apr. 16, 1998, now Pat. No. 5,961,035.
Application No. 09/061,302 is a continuation-in-part of application No. 08/731,586, filed on Oct. 16, 1996, now Pat. No. 5,833,130.

(51) Int. Cl. A21D 13/00; B65B 5/04; B65B 63/08

(52) U.S. Cl. 53/440; 426/106; 426/110; 426/115; 428/128; 426/392; 53/467

(57) ABSTRACT

A heat-retaining boxing and holding method involving placing a recently-cooked pizzeria pizza into a corrugated box having one or more thermal-legs, thereby creating a pizza-loaded thermal-leg-equipped box.

### CROSS-REFERENCES TO RELATED APPLICATIONS

1. This is a continuation-in-part application of my application Ser. No. 09/551,245, entitled “Versatile Pizza Carton,” filed Apr. 17, 2000, and of my application Ser. No. 09/394,784, entitled “Quality-enhancing Pizza Carton,” filed Sep. 13, 1999, which is a continuation-in-part of application Ser. No. 09/061,302, entitled “Designer Pizza Box with Enhancements,” filed Apr. 16, 1998, now U.S. Pat. No. 5,961,035, which is a continuation-in-part of application Ser. No. 08/731,586, entitled “Multi-function Pizza Carton, filed Oct. 16, 1996, now U.S. Pat. No. 5,833,130.

### FIELD OF THE INVENTION

2. This invention relates to packaging and to boxing and holding methods for hot pizzeria pizza.

### DESCRIPTION OF THE PRIOR ART

3. Each year the pizzeria industry sells millions of hot pizzas in corrugated boxes for delivery and carry-out. The eating enjoyment of those pizzas is, in large part, determined by the temperature of the product at the time the pizza-eater consumes it. So providing for a hotter boxed pizza is a priority of many pizza companies.

4. A conventional pizza holding method is currently applied. That method involves (a) placing a recently-cooked (i.e., hot) pizza into a conventional corrugated pizza box, (b) transporting the pizza-loaded box to an outlying place of consumption, such as a pizza-eater's residence, and, once there, (c) setting the pizza-loaded box onto a cool support surface, such as a table or counter. While sitting on the table the bottom panel of the box contacts the tabletop. This contact results in conduction of heat from the pizza through the box's bottom panel and into the table. That, in turn, contributes to rapid cooling of the pizza. Therefore, it would be desirable to eliminate the contact of the bottom panel of the corrugated pizza box with the tabletop and, thereby, slow down the rate of cooling of the pizza.

5. In addition to contact with a tabletop, contact of the bottom panel of the box with any cool surface expedites cooling of the pizza. Typical cool surfaces which the pizza-loaded box might contact include (a) the floor of an automotive vehicle, (b) the cover of another pizza-loaded box, and (c) the inside surface or support platform of a delivery pizza holding device, such as a delivery bag or rigid foam box. It would be desirable to eliminate contact of the bottom panel of a pizza-loaded box with these surfaces.

6. Since some pizza orders involve two pizzas, the conventional holding method also may involve stacking one pizza-loaded box on top of another. Lastly, for delivery pizza, the method often involves inserting the pizza-loaded box into a heat-retentive holding device such as a delivery bag.

7. In addition to heat loss, a further problem occurs when two loaded boxes are stacked. The bottom panel of the upper box is put into contact with the cover of the lower box. This results in condensation build-up within the cover of the lower box, making for an undesirably soggy box top. So it also would be desirable to have a method of holding hot pizza whereby the bottom panel of the upper box is kept free of contact with the cover of the lower box.

8. In short, it would be desirable to have a method of holding recently-cooked pizzeria pizza in a corrugated box whereby the loss of heat from the pizza through the bottom panel of the box is reduced, thereby keeping the pizza hot for a longer time.

9. In addition to the conventional holding method, the prior art contains several other pizza holding methods. They include those disclosed in Faller U.S. Pat. No. 4,260,060 (Food Carton for Microwave Heating) granted Apr. 7, 1981; France U.S. Pat. No. 5,253,800 (Pizza Tray) granted Oct. 19, 1993; Valdman et al. U.S. Pat. No. 5,423,477 (Pizza Box) granted Jun. 13, 1995; and Correll U.S. Pat. No. 5,549,241 (Interlock for Stackable Boxes) granted Aug. 27, 1996. In addition, there's a rigid foam insulating tray, called the Pizza Caddy, which adhesively secures to the bottom of a pizza box for reducing condensation, catching leakage, and preventing burning of the legs when carrying it on one's lap. However, each of these methods is either inapplicable or has a major drawback as regards the pizzeria industry.

10. The Faller method does not pertain to holding hot pizzeria pizza but, instead, involves holding a frozen pizza in a carton having a bottom panel with downward-projecting tabs. This method is used for heating frozen pizza in a microwave oven. As such it's not applicable to delivery and carry-out of hot pizza.

11. The France method does not involve a box but, rather, involves serving a pizza on an open tray having tabs projecting downward below the bottom panel. As such, this method doesn't apply to packaging and transporting a hot pizza in a closed container or box and, as a result, does not apply to improving heat-retention of boxed pizza.

12. The Valdman et al. method cannot be used with a corrugated carton. Instead, it requires a container made of molded paper pulp. The carton has a circular perimeter edge and a raised bottom panel. In addition, the process for making this type of carton is slow and, therefore, expensive; making it an unfeasible and undesirable method of packaging pizza.

13. The Correll method (U.S. Pat. No. 5,549,241) involves packing a pizza in a box having four downward projecting tabs that extend about six millimeters below the bottom panel of the box. However, these tabs do not extend far enough below the bottom panel to hold the bottom of a large Eflute corrugated box above a support surface once the bottom panel warps downward due to the steam of the hot pizza. Therefore, this method provides little or no reduction in conductive heat loss through the bottom panel of the box. Hence, it provides little or no heat-retentive benefit.

14. The Pizza Caddy method does not actually pertain to a box, per se, but instead involves sticking a rigid foam insulating tray to the bottom of a box. As such, it's time-consuming and also expensive, which are major drawbacks to many pizza companies.

15. So, there has remained a problem of how to easily and economically box and hold a hot pizza in a corrugated box so that heat loss via conduction through the bottom panel of the box is minimized. There has also remained a problem of how to stack two loaded corrugated boxes so that there is no condensation build-up on the bottom and top panels of the upper and lower boxes, respectively. These problems have not been solved by the prior art but are solved by my invention. By solving these problems, a pizza company can provide economical boxed pizza that stays hot for a longer period of time, thereby providing a more-enjoyable pizza-eating experience to its customers, and can do it without incurring substantial additional packaging cost and operational inconvenience.

### OBJECT AND ADVANTAGES

16. Accordingly, the main object of my invention is a reduction in heat loss of a recently-cooked pizza held in a corrugated box. A secondary object is a reduction in condensation build-up on a cover of a paperboard box when two loaded pizza boxes are stacked one on top of the other.

17. The advantages of my invention are (a) hotter boxed pizza for pizza consumers, without incurring substantial additional cost and operational inconvenience for pizza companies, and (b) pizza delivered in a dryer box when multiple pizza boxes are stacked.

18. Further objects and advantages of the invention will become apparent from consideration of the following detailed description, related drawings, and appended claims.

### SUMMARY OF THE INVENTION

19. My invention is a heat-retaining boxing and holding method involving placing a recently-cooked pizzeria pizza into a thermal-leg-equipped corrugated box, thereby creating a pizza-loaded thermal-leg-equipped box.

20. A complete understanding of the invention can be obtained from the detailed description that follows.

### BRIEF DESCRIPTION OF THE DRAWINGS

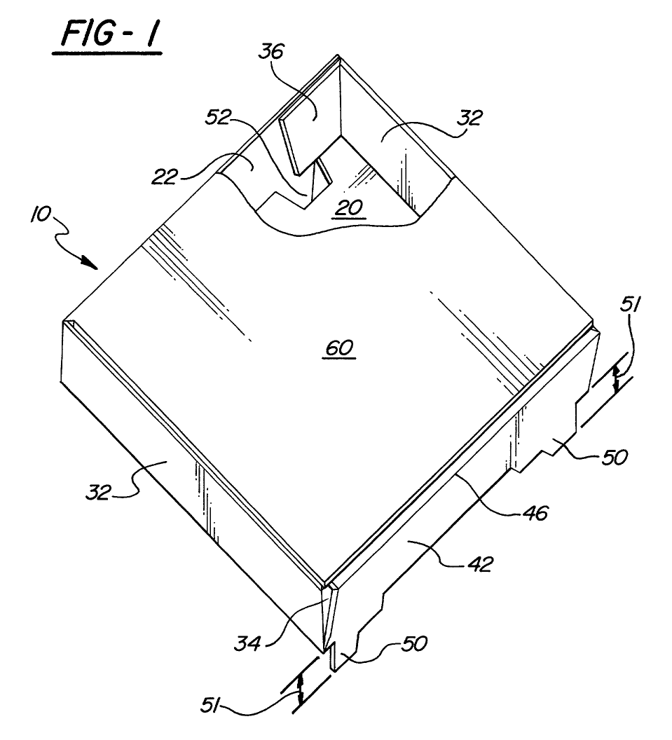

21. FIG. 1 is a perspective view of the preferred box for use with the method.

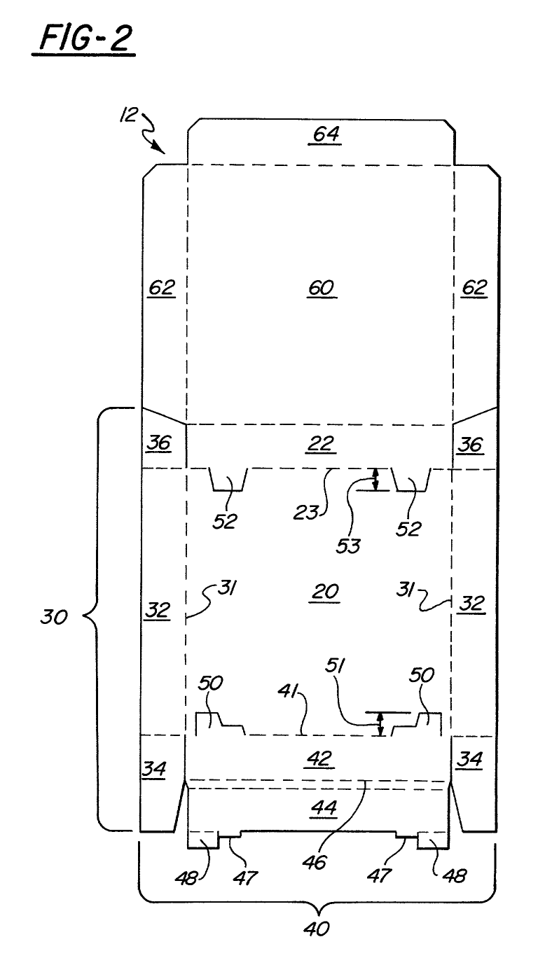

22. FIG. 2 is a plan view of the blank for making the preferred box of FIG. 1.

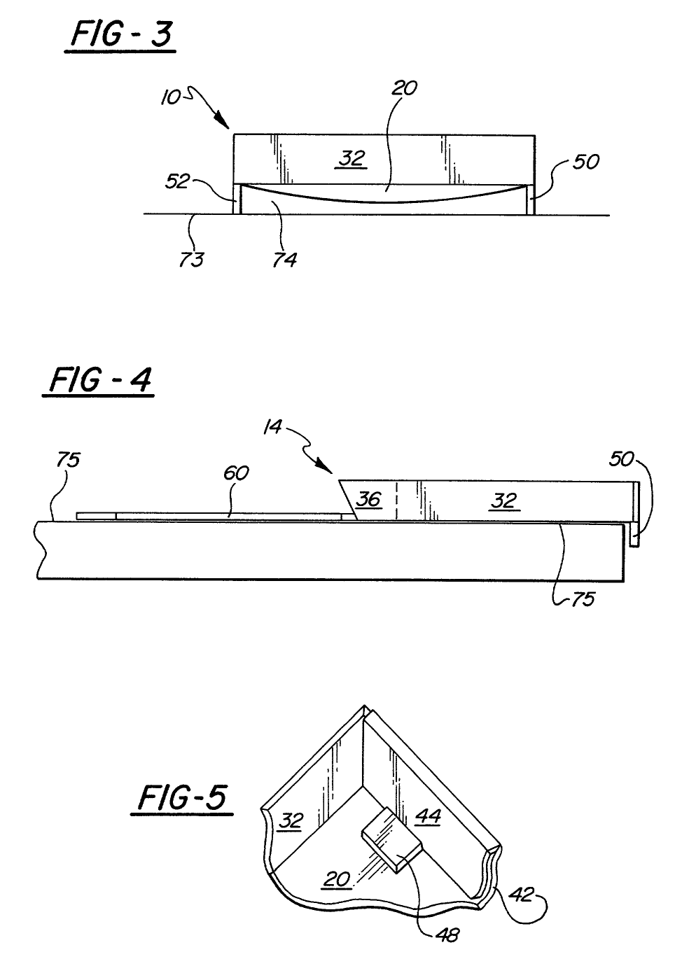

23. FIG. 3 is a left side elevation view of the preferred box loaded with pizza, sitting on a support surface.

24. FIG. 4 is a left side elevation view of the preferred box in partially-erected, or open, disposition, sitting on a support surface.

25. FIG. 5 is an inside perspective view of the right front corner section of the preferred box.

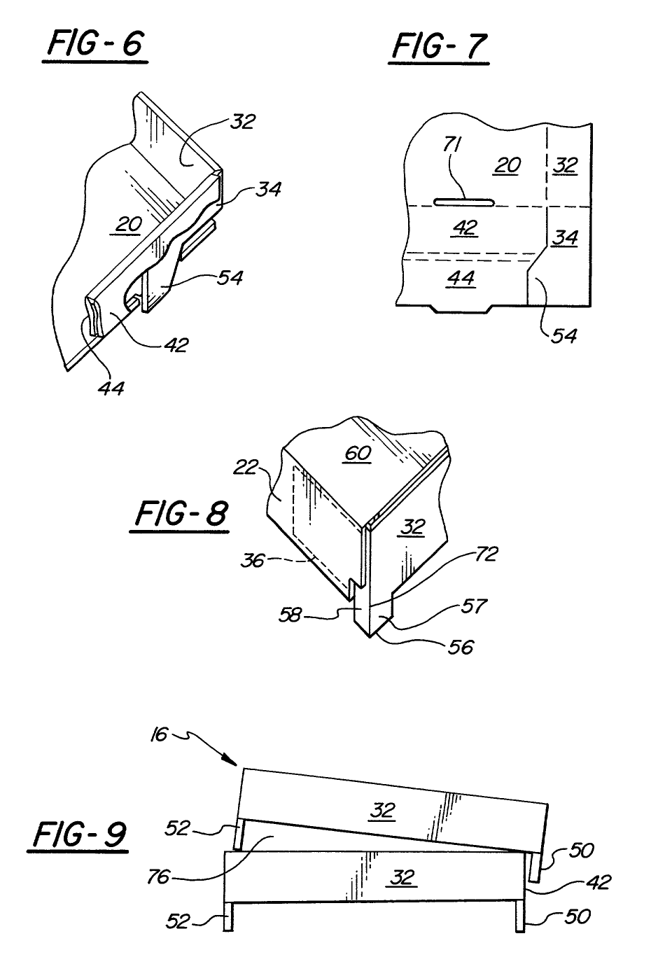

26. FIG. 6 is a cut-away perspective view of a right front corner section of an alternate open box that shows an alternate configuration of thermalleg.

27. FIG. 7 is a section of blank for making the structure shown in FIG. 6.

28. FIG. 8 is a perspective view of a rear corner section of an alternate closed box that shows an alternate configuration of thermal-leg.

29. FIG. 9 is a left side elevation view of a stack of preferred boxes.

### LIST OF REFERENCE NUMERALS

30. Between drawings, like reference numerals designate corresponding parts.

31.

32. 10 preferred box in closed, or fully-erected, format

33. 12 blank for the preferred box

34. 14 preferred box in open, or partially-erected, format

35. 16 stack of preferred boxes

36. 20 bottom panel

37. 22 rear wall

38. 23 bottom edge of rear wall

39. 30 side wall structure

40. 32 side wall

41. 34 front corner flap

42. 36 rear corner flap

43. 40 front wall structure

44. 42 outer wall panel

45. 44 inner wall panel

46. 46 pair of fold lines

47. 47 tab

48. 48 hole-covering flap

49. 50 front thermal-leg

50. 51 height of thermal-leg

51. 52 rear thermal-leg

52. 53 height of thermal-leg

53. 54 alternate thermal-leg

54. 56 alternate thermal-leg

55. 57 first portion

56. 58 second portion

57. 60 cover

58. 62 cover side flap

59. 64 cover front flap

60. 71 slot

61. 72 fold line

62. 73 support surface

63. 74 air gap

64. 75 pizza-cutting support surface

65. 76 air gap

### DESCRIPTION OF THE PREFERRED BOX FOR USE WITH THE METHOD

66. The heat-retaining boxing and holding method described herein involves a box having one or more thermal-legs, otherwise called a thermal-leg-equipped box. That particular type of box is now defined and described.

67. As referenced herein, a “box” is defined as a multi-paneled carton made of foldable material which, when fully erected, is enclosed on all sides to produce an enclosed inner cavity. A tray, which is a carton that's open on the top and/or the ends when it's in fully-erected disposition, is not considered to be a box and, therefore, is not usable with this method.

68. A “paperboard box” is a box made of paperboard. A “corrugated box” is a box made of corrugated paperboard. A “one-piece box” is a box that has a cover hingedly attached to one of the wall panels of the box. So a “one-piece corrugated box” is a box made of corrugated paperboard and which has a cover hingedly attached to one of the wall panels.

69. A “thermal-leg-equipped box” is a box having at least one thermal-leg.

70. A “thermal-leg,” as the term is used herein, is defined as a downward projection of a wall structure of a box, that projection extending beyond a bottom edge of an adjacent wall panel by a distance of at least nine millimeters when the box is in a fully-erected format. A projection that does not extend at least nine millimeters beyond a bottom edge of an adjacent wall panel is NOT considered to be a thermal-leg. A “wall structure” can consist of a single wall panel, a plurality of hingedly connected wall panels, or a combination of one or more wall panels with one or more corner flaps attached thereto. Accordingly, a wall structure can be of double-panel construction, which could involve an outer wall panel and an inner wall panel hingedly linked to the outer wall panel and disposed parallel to it. A thermal-leg can project from a wall panel (including either an outer wall panel or an inner wall panel) and/or from a corner flap attached to a wall panel.

71. So, a “thermal-leg-equipped box” is defined as a box that has at least one thermal-leg extending beyond a bottom edge of an adjacent wall panel by a distance of at least nine millimeters. A “thermal-leg-equipped one-piece corrugated box” is a thermal-leg-equipped box made of corrugated paperboard and which has a cover hingedly attached to one of the wall panels of the box.

72. Finally, a “pizza-loaded thermal-leg-equipped box” is a thermal-leg-equipped box that's holding a pizza.

73. Referring now to FIG. 1, there is shown a thermal-leg-equipped one-piece corrugated box 10, which is the preferred type of thermal-leg-equipped box used in the heat-retaining boxing and holding method described herein. FIG. 2 shows a blank 12, which is the blank used for creating box 10. Those components of the box which are not visible in FIG. 1 are visible in FIG. 2.

74. Before starting the description, it is noted that corresponding parts between drawings share a same reference numeral. It is further noted that the box and blank are bilaterally symmetrical. Therefore, pairs of opposing like components are to be found, with one item of the pair on each side of the box or blank. For simplicity of labeling, each component pair may be indicated by a numeral on one side of the drawing only. Where this occurs, it is to be understood that the discussion also applies to the corresponding component on the other side, even though that component may not be numerically labeled.

75. Blank 12 and box 10 have a bottom panel 20. A rear wall 22 is hingedly attached to bottom panel 20 at a fold line 23 (which also represents the bottom edge of rear wall 22).

76. A pair of opposing side wall structures 30 are attached to bottom panel 20 at fold lines 31. Each side wall structure 30 comprises a side wall 32, a front corner flap 34, and a rear corner flap 36.

77. A double-panel front wall structure 40 is attached to bottom panel 20 at a fold line 41 (which also represents the bottom edge of outer wall panel 42). Front wall structure 40 comprises an outer wall panel 42, an inner wall panel 44 hingedly linked to a top edge of panel 42 at a pair of narrowly-spaced parallel fold lines 46, a pair of tabs 47 projecting from a bottom edge of inner wall panel 44, and a pair of hole-covering flaps 48 hingedly attached to inner wall panel 44. Tab 47 holds front wall structure 40 in upright disposition when the box is in erected format.

78. Projecting from outer wall panel 42 are a pair of front thermal-legs 50. Projecting from rear wall 22 are a pair of rear thermal-legs 52. Every thermal-leg has a particular height, which is the distance that the thermal-leg extends beyond the bottom edge of an adjacent wall. Thermal-legs 50 have a height 51, which is the distance that thermal-legs 50 extend beyond bottom edge 41 of outer wall panel 42. Thermal-legs 52 have a height 53, which is the distance that thermal-legs 52 extend beyond bottom edge 23 of rear wall 22.

79. Heights 51 and 53 are at least nine millimeters. (If the height of a leg-type projection is less than nine millimeters, the projection is not considered to be a thermal-leg as regards the inventive method described herein.) However, it can be desirable for a thermal-leg height to be greater than nine millimeters, such as being ten, eleven, twelve or more millimeters. The proper height for particular thermal-legs depends on the flute thickness of the corrugated board of the box and on the size of the box. Generally, the thinner the flute and the larger the box, the longer the height that the thermal-legs should be. That's because thinner flutes and larger box sizes tend to result in a greater degree of downward warp in the bottom panel of a pizza-loaded box, which must be compensated for by a greater height of thermal-legs. The downward warp of bottom panel 20 of a pizza-loaded box 10 is illustrated in FIG. 3, which shows box 10 sitting on a support surface 73 with an air gap 74 between downward-warping bottom panel 20 and support surface 73

80. A cover 60 is hingedly attached to a top edge of rear wall 22. A pair of cover side flaps 62 and a cover front flap 64 are hingedly attached to cover 60.

81. It is noted that rear thermal-legs 52 are open-carton-retracting thermal-legs. “Open-carton-retracting thermal-legs” are thermal-legs that are disposed in an upright position when the box is in closed, or fully-erected, format (as depicted in FIG. 1) but move to a non-upright, or retracted, position when the cover is laid back, thereby putting the box in open or partially-erected format, as depicted by box 14 in FIG. 4. Accordingly, when cover 60 of partially-erected box 14 is closed upon the box, the forward movement of the cover causes rear wall 22 to move from a coplanar to a perpendicular position in relation to bottom panel 20. That change in rear wall position simultaneously causes rear thermal-legs 52 to move from a non-upright position to an upright position. The typical non-upright position has the thermal-legs disposed approximately coplanar to the bottom panel but any position that's less than a full upright position would be considered to be non-upright.

82. Lastly, it is noted (see FIG. 1) that adjacent to rear thermal-legs 52 is an opening in the bottom of the box (which results from creating the thermal-leg). Because of this opening, conventional steam vent openings which are usually found in or around the cover of a pizza box are probably not needed. Further, it is noted that there would also be openings next to front thermal-legs 50, except that these openings are covered by hole-covering flap 48, depicted in FIG. 5.

### ALTERNATE CONFIGURATIONS OF THERMAL-LEGS AND THERMAL-LEG-EQUIPPED BOXES

83. Even though the above-described box is the preferred box for use with the invented method, it should be appreciated that other configurations of thermal-legs and thermal-leg-equipped boxes can be used. Some of these boxes are disclosed and discussed in prior patents and patent applications of mine: specifically, in Correll U.S. Pat. No. 5,833,130 (Multi-function Pizza Carton), Correll U.S. Pat. No. 5,961,035 (Designer Pizza Box with Enhancements), Correll U.S. patent application Ser. No. 09/394,784 (Quality-enhancing Pizza Carton), and Correll U.S. patent application Ser. No. 09/551,245 (Versatile Pizza Carton). The structure and discussion of thermal-legs and thermal-leg-equipped boxes disclosed in these patents and applications are included herein by reference thereto.

84. In the preferred box thermal-legs extend from wall panels. However, it's possible for thermal-legs to extend from corner flaps, as well. This is disclosed in Correll U.S. Pat. No. 5,961,035 (Designer Pizza Box with Enhancements) and Correll U.S. patent application Ser. No. 09/551,245 (Versatile Pizza Carton) . A first example is illustrated in FIG. 6, which shows a cut-away right front corner section of an open box. In the Figure, a thermal-leg 54 extends from a bottom edge of a front corner flap 34. FIG. 7 shows this structure in the blank format, which includes a slot 71 through which thermal-leg 54 extends when the blank is erected into a box.

85. A second example is illustrated in FIG. 8, which shows a rear corner section of a closed box. What is shown is a two-part combination thermal-leg 56 extending jointly from a side wall 32 and a rear corner flap 36 (which in the drawing is covered by a rear wall 22.) The two parts of thermal-leg 56 are a first portion 57 and a second portion 58. Portion 57 extends from side wall 32 and portion 58 extends from rear corner flap 36. The two portions are joined at a fold line 72 and are disposed perpendicularly.

86. Although an example is not shown, it is noted that it's also possible for a thermal-leg to project from inner wall panel 44.

### DESCRIPTION OF A PREFERRED EMBODIMENT OF THE METHOD

87. This invention is a method of boxing and holding recently-cooked (i.e., hot) pizzeria pizza for reduced heat loss. The method has been alluded to and discussed in previous U.S. patent applications of mine: specifically, application Ser. No. 09/551,245 (Versatile Pizza Carton) filed Apr. 17, 2000; application Ser. No. 09/394,784 (Quality-enhancing Pizza Carton) filed Sep. 13, 1999; application Ser. No. 09/061,302 (Designer Pizza Box with Enhancements) filed Apr. 16, 1998, now U.S. Pat. No. 5,961,035; and application Ser. No. 08/731,586 (Multi-function Pizza Carton) filed Oct. 16, 1996, now U.S. Pat. No. 5,833,130.

88. Each of those applications and patents refers to boxing and holding a recently-cooked pizza in a corrugated box having at least one thermal-leg projecting downward below the bottom panel of the box, whereby the bottom panel of the box is held out of contact with a cool support surface such as a tabletop or a floor of an automotive vehicle. As used herein, a “cool support surface” is defined as a support surface that has a temperature that's cooler than the temperature of the pizza in the box.

89. A preferred embodiment of the method comprises the following steps.

90. STEP A: Positioning a thermal-leg-equipped one-piece corrugated box (e.g., box 10) on a pizza-cutting support surface in a disposition wherein the bottom panel of the box is disposed in contact with the support surface. This disposition allows a pizza to be cut in the box without bending the thermal-legs. Typical pizza-cutting support surfaces include the top of a table, counter, cutting board, or wire rack.

91. The best way to position bottom panel 20 in contact with a pizza-cutting support surface is to position front thermal-legs 50 below the plane of the support surface. And an easy way to position thermal-legs 50 below the plane of a support surface is to position them off an edge of the support surface. This disposition is illustrated in FIG. 4, which shows a left side view of partially-erected box 14 sitting on top of pizza-cutting support surface 75, with thermal-legs 50 disposed off of support surface 75 and, thereby, below the plane of support surface 75. It is noted that support surface 75 is any surface upon which the box rests while the pizza is being cut in the box. In FIG. 4 a slight gap is shown between box 14 and support surface 75. This is to clearly differentiate the box from the support surface; typically the box would sit directly on the support surface.

92. In addition, it's possible to have a pizza-cutting support surface that has openings in it sized to allow thermal-legs to fit into them, thereby allowing the thermal-legs to be disposed below the plane of the support surface and, thereby, enabling the bottom panel of the box to be in contact with the support surface.

93. STEP B: Placing a recently-cooked pizzeria pizza into the thermal-leg-equipped one-piece corrugated box, whereby a pizza-loaded thermal-leg-equipped box is created.

94. STEP C: Transporting the pizza-loaded thermal-leg-equipped box from the pizzeria to an outlying place of consumption. The most common outlying place of consumption is the pizza-eater's residence, although any place where the pizza is consumed (i.e., workplace, picnic, etc.) is considered to be an outlying place of consumption.

95. STEP D: Setting the pizza-loaded thermal-leg-equipped box on a support surface located at the outlying place of consumption. Typical support surfaces are tabletop and countertop. The way most consumers eat boxed pizza is that they open the box, remove a slice of pizza for eating, and then reclose the box to keep the remaining pizza hot. While in closed format, the bottom panel of the pizza-loaded thermal-leg-equipped box is held above, or free of contact with, the relatively cool support surface (as illustrated in FIG. 3). Because of this, the pizza undergoes a slower rate of cooling than if the bottom panel of the box were in contact with the support surface.

96. Although four steps are described above, the essence of the method is contained in the placing step (step B): specifically, placing a recently-cooked pizzeria pizza into a thermal-leg-equipped box, thereby creating a pizza-loaded thermal-leg-equipped box. Even when the other steps are omitted, the inventive essence of the method still remains as long as the placing step is performed. Once the pizza is placed in the thermal-leg-equipped box, whenever that pizza-loaded thermal-leg-equipped box is placed on a cool support surface the bottom panel of the box is held above, or out of contact with, the cool support surface, thereby achieving the object of the method.

### VARIATIONS OF THE METHOD

97. The foregoing method describes a preferred embodiment, but other configurations of the method are possible. Examples of some common possible variations are as follows.

98. Variation 1: The positioning step is omitted. This could occur when a pizza is cut prior to loading it into the box.

99. Variation 2: The positioning step is performed subsequent to the placing step (rather than before). With this, the pizza-loaded thermal-leg-equipped box is positioned on a pizza-cutting surface in a disposition wherein the bottom panel of the box is disposed in contact with the support surface. This enables the pizza to be cut in the box without bending the thermal-legs.

100. Variation 3: The following step is performed subsequent to the placing step and before the transporting step: Setting the pizza-loaded thermal-leg-equipped box on a support surface. Typical support surfaces would be a tabletop, countertop, routing shelf, pick-up shelf, cover of a pizza box, box-support surface inside of a delivery pizza holding device such as a delivery bag or rigid foam box, and floor of an automotive vehicle. Setting the box on a floor of an automotive vehicle typically occurs with pick-up pizzas that are transported by the customer (as opposed to a delivery driver). In a delivery bag the box-support surface would be the inside surface or inner liner of the bag and also may be any board or board-type shelf inside the bag.

101. It is noted that while sitting on any of the above-cited support surfaces the bottom panel of the box is held above, or free of contact with, the support surface by the thermal-legs, thereby creating an air gap between the box and support surface. This is illustrated in FIG. 3 which shows air gap 74 between the box and support surface. It is noted that the temperature of most support surfaces is cooler than that of the pizza. Therefore, by holding the bottom panel of the box out of contact of the cool support surface, the pizza undergoes a slower rate of cooling than if the bottom panel were in contact with the support surface.

102. Variation 4: The following step is performed subsequent to the placing step: Stacking the pizza-loaded thermal-leg-equipped box on top of a second pizza-loaded thermal-leg-equipped box with either the front or the rear thermal-legs of the pizza-loaded thermal-leg-equipped box sitting on the cover of the second pizza-loaded thermal-leg-equipped box, thereby creating an air gap between the boxes. This is illustrated in FIG. 9 which shows a stack 16 of upper and lower pizza-loaded thermal-leg-equipped boxes with rear thermal-legs 52 of the upper box sitting on the cover of the lower box, thereby creating air gap 76 between the boxes. It is also noted that front thermal-legs 50 of the upper box are disposed on an exterior side of outer wall panel 42 of the lower box. This configuration enables the stack of boxes to be easily grasped with one hand. Finally, air gap 76 provides a secondary benefit of preventing condensation build-up on the cover of the lower box, thereby maintaining the cover of the lower box in a relatively dry (non-soggy) state.

103. Finally, combinations of the above four variations are possible.

### CONCLUSION, RAMIFICATIONS, AND SCOPE

104. I have disclosed a heat-retaining boxing and holding method for pizza involving placing a recently-cooked pizzeria pizza into a thermal-leg-equipped corrugated box, thereby creating a pizza-loaded thermal-leg-equipped box. This method has been alluded to and discussed in four prior patent applications of mine, which have been previously cited.

105. I have laid out an embodiment of the method comprising four steps. However, many variations of the method are possible within the scope of the invention, some of which have been described above.

106. I have also described a preferred type of thermal-leg-equipped one-piece corrugated box recommended for use with the method. That box contains particular types of thermal-legs. I have also described two alternate types of thermal-legs. However, many other configurations of thermal-leg-equipped boxes and thermal-legs are possible within the scope of the invention.

107. On the preferred box four thermal-legs were shown; however, other numbers of thermal-legs are possible and would be regarded as being within the scope of the invention. For example, it's possible to have a box with only a single thermal-leg or with multiple thermal-legs disposed along one wall of the box only. In this situation, when the box is sitting on a support surface, the bottom edge of the opposing wall would rest on the support surface and, therefore, the bottom panel of the box would be disposed obliquely to the support surface as opposed to parallel to it.

108. In conclusion, it is understood that the invention is not to be limited to the disclosed embodiments and variations but, on the contrary, is intended to cover various modifications and equivalent arrangements included within the spirit and scope of the appended claims, which scope is to be accorded the broadest interpretation so as to encompass all such modifications and equivalent structures as is permitted under the law.

I claim:

1. A method of boxing and holding a recently-cooked pizzeria pizza, said method comprising the step of:
placing said pizza into a thermal-leg-equipped one-piece corrugated box, whereby a pizza-loaded thermal-leg-equipped box is created, said pizza-loaded thermal-leg-equipped box comprising a bottom panel, a plurality of wall structures, at least one thermal-leg, a cover, and said pizza.

2. The method of claim 1 further comprising the following step occurring subsequent to the placing step:
transporting said pizza-loaded thermal-leg-equipped box from a pizzeria to an outlying place of consumption.

3. The method of claim 1 further comprising the following step occurring subsequent to the placing step:
setting said pizza-loaded thermal-leg-equipped box on a cool support surface, wherein said at least one thermal-leg sits on the support surface and said bottom panel is free of contact with the support surface;
whereby said pizza undergoes a slower rate of cooling than would occur if said bottom panel were in contact with the support surface.

4. The method of claim 3 wherein:
said cool support surface is a tabletop in a residence of a pizza consumer.

5. The method of claim 3 wherein:
said cool support surface is a floor of an automotive vehicle.

6. The method of claim 3 wherein:
said cool support surface is a cover of a pizza box.

7. The method of claim 3 wherein:
said cool support surface is a box-support component of a delivery pizza holding device.

8. The method of claim 1 further comprising the following step occurring prior to the placing step:
positioning said thermal-leg-equipped one-piece corrugated box on a pizza-cutting support surface in a disposition wherein at least one thermal-leg of the box is disposed below a plane of said pizza-cutting support surface.

9. The method of claim 1 further comprising the following step occurring prior to the placing step:
positioning said thermal-leg-equipped one-piece corrugated box on a pizza-cutting support surface in a disposition wherein a bottom panel of said thermal-leg-equipped one-piece corrugated box is in contact with said pizza-cutting support surface.

10. The method of claim 1 further comprising the following step occurring subsequent to the placing step:
positioning said pizza-loaded thermal-leg-equipped box on a pizza-cutting support surface in a disposition wherein said at least one thermal-leg is disposed below a plane of said pizza-cutting support surface.

11. The method of claim 1 further comprising the following step occurring subsequent to the placing step:
positioning said pizza-loaded thermal-leg-equipped box on a pizza-cutting support surface in a disposition wherein the bottom panel of said pizza-loaded thermal-leg-equipped box is in contact with said pizza-cutting support surface.

12. The method of claim 2 wherein:
said pizza-loaded thermal-leg-equipped box further comprises first and second thermal-legs respectively projecting from opposing first and second wall structures.

13. The method of claim 12 further comprising the following step occurring between the placing and transporting steps:
stacking said pizza-loaded thermal-leg-equipped box on top of a second pizza-loaded thermal-leg-equipped box, wherein at least one of the first and second thermal-legs of said pizza-loaded thermal-leg-equipped box sits on a cover of said second pizza-loaded thermal-leg-equipped box, whereby a substantial air gap between the boxes is maintained.

14. The method of claim 12 further comprising the following step occurring between the placing and transporting steps:
stacking said pizza-loaded thermal-leg-equipped box on top of a second pizza-loaded thermal-leg-equipped box, wherein at least one of the first and second thermal-legs of said pizza-loaded thermal-leg-equipped box is disposed on an exterior side of a wall of said second pizza-loaded thermal-leg-equipped box.

15. The method of claim 12 further comprising the following step occurring between the placing and transporting steps:
stacking said pizza-loaded thermal-leg-equipped box on top of a second pizza-loaded thermal-leg-equipped box, wherein one of the first and second thermal-legs of said pizza-loaded thermal-leg-equipped box sits on a cover of said second pizza-loaded thermal-leg-equipped box and the other of said first and second thermal-legs is disposed on an exterior side of a wall of said second pizza-loaded thermal-leg-equipped box.

16. The method of claim 2 wherein:
said at least one thermal-leg has a height of at least ten millimeters.

17. The method of claim 2 wherein:
said at least one thermal-leg has a height of at least eleven millimeters.

18. The method of claim 2 wherein:
said at least one thermal-leg has a height of at least twelve millimeters.

19. The method of claim 2 wherein:
said at least one thermal-leg projects from a corner flap.

20. The method of claim 2 wherein:
said at least one thermal-leg comprises a first portion joined at a fold line to a second portion, said first portion being disposed at an angle to said second portion.

21. The method of claim 2 wherein:
said at least one thermal-leg is an open-carton-retracting thermal-leg.

22. The method of claim 2 wherein:
said pizza-loaded thermal-leg-equipped box includes at least one hole-covering flap.
